(19) United States
(12) Patent Application Publication
(10) Pub. No.: US 2023/0369920 A1
(43) Pub. Date: Nov. 16, 2023

(54) MOTOR COMPONENT, MOTOR AND MOTOR VEHICLE

(71) Applicant: Valeo Automotive ePowertrain Systems (Shanghai) Co., Ltd., Shanghai (CN)

(72) Inventors: Huafeng MAO, Shanghai (CN); Renlong YING, Shanghai (CN); Xuehua ZHANG, Shanghai (CN); Wei ZHU, Shanghai (CN); Robin BUESCH, Bad Neustadt a.d.Saale (DE); Andreas ECKERT, Bad Neustadt a.d.Saale (DE)

(73) Assignee: Valeo Automotive ePowertrain Systems (Shanghai) Co., Ltd., Shanghai (CN)

(21) Appl. No.: 18/246,946

(22) PCT Filed: Sep. 28, 2021
(86) PCT No.: PCT/CN2021/121348

§ 371 Date: Mar. 28, 2023

(30) Foreign Application Priority Data
Sep. 29, 2020 (CN) 202011054325.X

(51) Int. Cl. H02K 1/06

(52) U.S. Cl. CPC H02K 1/06; H02K 2201/09

(57) ABSTRACT

A motor component, a motor and a motor vehicle are disclosed. The motor component has a body extending along a rotation axis of the motor, the body being formed by a set of laminations, and an axially extending cavity being provided on the body; and wherein at least one elongated lamination-holding component is provided in the body, and the lamination-holding component is inserted into the axially extending cavity and is coupled to the body inside the axially extending cavity.

### TECHNICAL FIELD

The present disclosure relates to a field of motors, and more specifically to a motor component, a motor and a motor vehicle.

### BACKGROUND

With the widespread application of motors in civil and commercial fields, motors, especially motor components in motors, are also facing higher requirements.

A current motor component (such as a motor stator or a motor rotor) is usually formed by a set of laminations, and laminations in the set of laminations are tightly designed to ensure rigidity and strength of the motor component. In order to prevent decrease in rigidity and strength caused by increase in gaps between the laminations during operation of the motor, end plates are usually set at both ends of the motor component, and the end plates are locked in place by press-fitting, so that the laminations in the set of laminations are still tightly arranged when the motor is running. However, in the case where end plates are arranged, on the one hand, additional screws, nuts need to be added to the motor component, or corresponding threads need to be set on the motor component, and a pressing and locking tool is required, which increases constitution elements of the motor component and increases the manufacturing cost; on the other hand, when end plates are used, since the end plates provide a magnetic flux path, the problem of magnetic flux leakage may occur, which affects operational performance and stability of the motor component.

Therefore, there is a need for a motor component with a simple structure, low manufacturing cost, convenient manufacturing process, as well as good operational performance and stability under the premise of achieving high rigidity and high strength, especially high rigidity and high strength during operation, of the motor component.

### SUMMARY OF THE DISCLOSURE

In view of the above problems, the present invention provides a motor component, a motor and a motor vehicle. The motor component provided by the present invention can maintain high rigidity and strength during operation, and the motor component has a simple structure, low manufacturing cost, convenient manufacturing process as well as good operational performance and stability.

According to an aspect of the present invention, a motor component is provided, the motor component having a body extending along a rotation axis of the motor, the body being formed by a set of laminations, and an axially extending cavity being provided on the body; and wherein at least one elongated lamination-holding component is provided in the body, and the lamination-holding component is inserted into the axially extending cavity and is coupled to the body inside the axially extending cavity.

The communication method of the present invention may further comprises one or more of the following features, individually or in combination.

In some embodiments, the motor component is a motor stator or a motor rotor.

In some embodiments, the lamination-holding component extends over a portion of a length of the axially extending cavity.

In some embodiments, the lamination-holding component extends over the entire length of the axially extending cavity.

In some embodiments, the lamination-holding component is coupled to the body by glue.

In some embodiments, a surface of the lamination-holding component is provided with a texture.

In some embodiments, the texture is serrations or threads.

In some embodiments, the laminate holding component is made of non-magnetic material.

In some embodiments, the lamination-holding component is coupled to the body by interference fit with the axially extending cavity.

In some embodiments, the axially extending cavity is a through-groove or a through-hole.

In some embodiments, the axially extending cavity is a permanent magnet mounting slot.

In some embodiments, the axially extending cavity is a balance pin mounting slot.

In some embodiments, the lamination-holding component is a rod having a cross section of square, rectangular, circular or elliptical.

According to another aspect of the present invention, a motor is provided, comprising the motor component as described above.

According to another aspect of the present invention, a motor vehicle is provided, comprising the motor as described above.

### BRIEF DESCRIPTION OF THE DRAWINGS

In order to explain technical solutions of embodiments of the present invention more clearly, accompanying drawings need to be used in description of the embodiments will be briefly introduced below. Obviously, the drawings in the following description are only some embodiments of the present invention. For those of ordinary skill in the art, other drawings can be obtained based on these drawings without paying creative effort. The following drawings are not deliberately scaled and drawn according to the actual size, and the focus is to show the gist of the present invention.

FIG. 1 shows an exploded view of a permanent magnet motor 100 provided with end plates;

FIG. 2 shows a schematic cross-sectional view of a lamination-holding component 250 inside the axially extending cavity according to an embodiment of the present disclosure;

FIG. 3 shows an exploded view of a motor 200 according to an embodiment of the present invention, in which a mounting slot of a permanent magnet in a motor rotor 220 serves as the axially extending cavity;

FIG. 4 shows a perspective view of the motor 200 in FIG. 2;

FIG. 5 shows a front view of the motor 200 in FIG. 2;

FIG. 6 shows a left view of the motor 200 in FIG. 2, in which the motor rotor 220 is not provided with a lamination-holding component;

FIG. 7 shows a left view of the motor 200 in FIG. 2, in which the motor rotor 220 is provided with a lamination-holding component;

FIG. 8 shows an axial sectional view of a permanent magnet mounting slot 270 of the motor rotor 220 in FIG. 2;

FIG. 9 shows a side view of a variant of the motor 200 according to an embodiment of the present disclosure;

FIG. 10 shows an axial cross-sectional view of a balance pin mounting slot 280 of the motor rotor 220 in the variant of the motor 200 as shown in FIG. 9.

### DESCRIPTION OF THE EMBODIMENTS

Technical solutions in the embodiments of the present invention will be clearly and thoroughly described below in conjunction with the accompanying drawings. Obviously, the described embodiments are only part of the embodiments of the present invention, rather than all the embodiments. All other embodiments obtained by those of ordinary skill in the art based on the embodiments of the present invention without paying creative effort shall fall within the protection scope of the present invention.

As shown in the present application and the claims, unless otherwise clearly stated in the context, words such as “a”, “an”, “one” and/or “the” and the like do not specifically refer to the singular, but may also include the plural. Generally, the terms “comprise” and “include” only suggest that those clearly identified steps and elements are included, while these steps and elements do not constitute an exclusive list, and a method or device may also include other steps or elements.

A current motor usually includes the following motor components: a motor stator and a motor rotor. The motor components (the stator and the rotor) are usually formed by a set of laminations, and the laminations in the set of laminations are tightly designed to ensure rigidity and strength of the motor components. In order to prevent decrease in rigidity and strength caused by increase in gaps between the laminations during operation of the motor, end plates are usually set at both ends of the motor components.

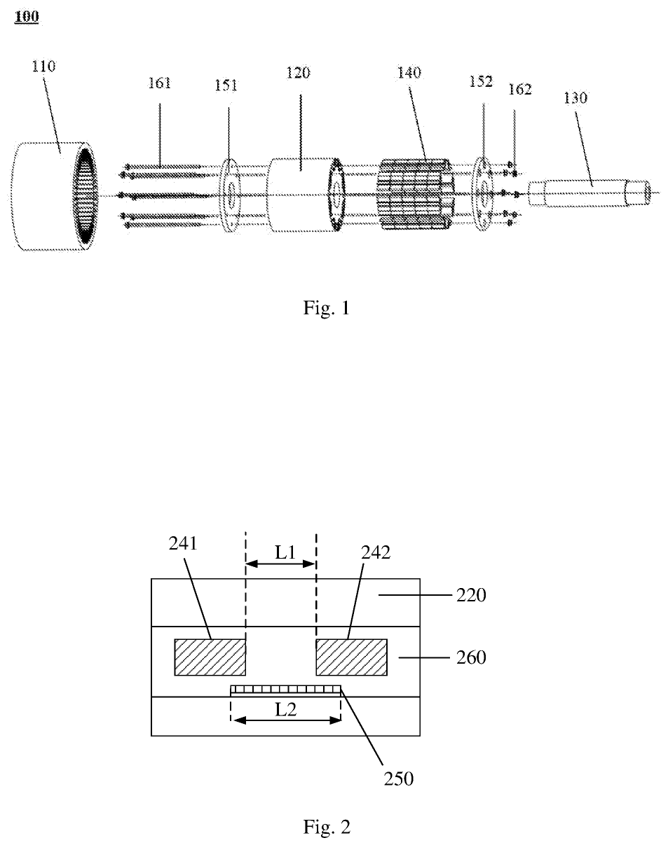

For example, taking a permanent magnet motor rotor as an example, FIG. 1 shows an exploded view of a permanent magnet motor 100 provided with end plates, in which the motor rotor is provided with end plates. Referring to FIG. 1, specifically, the permanent magnet motor 100 includes a motor stator 110, a motor rotor 120, a motor shaft 130 and a plurality of permanent magnets 140. The motor rotor 120 is also provided with a left end plate 151 and a right end plate 152. The left end plate 151 and the right end plate 152 are locked in place, for example, via screws 161, nuts 162, or corresponding threads within the right end plate 152, so that laminations in the lamination set of the motor are still tightly arranged when the motor is running, thereby improving structural strength and rigidity of the motor rotor.

However, in the case where end plates are arranged, on the one hand, additional screws, nuts need to be added to the motor component, or corresponding threads need to be set on the motor component, and a pressing and locking tool is required, which increases constitution elements of the motor component and increases the manufacturing cost; on the other hand, when end plates are used, since the end plates provide a magnetic flux path, the problem of magnetic flux leakage may occur, which affects operational performance and stability of the motor component.

In view of this, this application proposes a motor component, a motor and a motor vehicle, so that a simple structure, low manufacturing cost, convenient manufacturing process as well as good operational performance and stability can be realized under the premise of achieving high rigidity and high strength.

According to an aspect of the present disclosure, a motor component is proposed, the motor component having a body extending along a rotation axis of the motor, in which the rotation axis of the motor is intended to characterize a central axis when the motor rotates. The body is formed by a set of laminations, and an axially extending cavity is provided on the body.

The set of laminations is also referred to as a laminated set, which includes a plurality of sheets (hereinafter also referred to as laminations). This application is not limited by the number of sheets included in the lamination set and the material and shape of the sheets.

The axially extending cavity is intended to characterize a cavity extending in a direction parallel to the axis of rotation of the motor, which may be, for example, a through cavity that axially penetrates the body of the motor component, or a non-through cavity extending inwardly from an end of the body and only extending within a portion of the length inside the body. It should be understood that the embodiments of the present disclosure are not limited by whether the axially extending cavity penetrates the body of the motor component, nor are they limited by the specific length of the axially extending cavity extending within the body of the motor component.

Moreover, at least one elongated lamination-holding component is provided in the body, and the lamination-holding component is inserted into the axially extending cavity and is coupled to the body inside the axially extending cavity.

The lamination-holding component is a component intended to keep the plurality of laminations in the lamination set closely arranged. The embodiments of the present disclosure are not limited by a composition material, shape characteristics, and extension direction of the lamination-holding component. The embodiments of the present disclosure are also not limited by the specific number of lamination-holding components used in the motor component.

The lamination-holding component is inserted into the axially extending cavity, which is intended to mean that the axially holding component is integrally arranged inside the axially extending cavity and does not extend out of the axially extending cavity.

The lamination-holding component being coupled to the body inside the axially extending cavity may be described in more detail, for example: the lamination-holding component may be coupled to the body by glue, or the lamination-holding component may also be coupled to the body by interference fit, for example. It should be understood that the embodiments of the present disclosure are not limited by the specific manner in which the lamination-holding component is coupled to the body.

Based on the above description, in the present application, by arranging the lamination-holding component in the motor component, and inserting the lamination-holding component into the axially extending cavity and coupling it to the body inside the axially extending cavity, the plurality of laminations in the body of the motor component still have a compact layout when the motor component is in operation, thereby effectively improving structural strength and rigidity of the motor component, and the motor component has a simple structure, low manufacturing cost and a convenient manufacturing process. Furthermore, compared with the aforementioned method of adding end plates, the use of the lamination-holding component in this application can effectively reduce the magnetic flux leakage, so that the motor component has good operational performance and stability.

In some embodiments, the motor component is a motor stator or a motor rotor. It should be understood that the embodiments of the present disclosure are not limited by the specific type, model, size, and structure of the motor stator and motor rotor.

Based on the above description, in this application, by providing the motor component as a motor stator or a motor rotor, the structural strength and rigidity of the core components (the motor stator, the motor rotor) in the motor can be effectively enhanced, so that gaps between laminations in the body part of the motor stator or motor rotor will not increase during the operation of the motor, thereby further improving the overall performance characteristics of the motor.

In some embodiments, the lamination-holding component extends over a portion of a length of the axially extending cavity.

FIG. 2 shows a schematic cross-sectional view of a lamination-holding component 250 inside the axially extending cavity according to an embodiment of the present disclosure. Referring to FIG. 2, the lamination-holding component is, for example, a motor rotor 220, and FIG. 2 shows a schematic cross-sectional view of the motor rotor 220, in which only one axially extending cavity is shown, for example, and the axially extending cavity is, for example, a mounting slot 260 of a permanent magnet in the motor rotor. At this time, for example, a plurality of permanent magnets 241 and 242 are mounted in the permanent magnet mounting slot 260. In addition, there is a gap L1 between the permanent magnets 241 and 242, and the lamination-holding component 250, for example, only extends over a length L2 greater than the gap L1 inside the axially extending cavity.

Based on the above description, in the present application, by arranging the lamination-holding component extending over a portion of the length of the axially extending cavity, the cost can be saved to the greatest extent and the structure composition of the motor component can be simplified on the basis of improving the structural strength and rigidity of the body of the motor component.

In some embodiments, the lamination-holding component extends over the entire length of the axially extending cavity. By arranging the lamination-holding component extending over the entire length of the axially extending cavity, the structural strength and rigidity of the body of the motor component can be strengthened better.

In some embodiments, the lamination-holding component is coupled to the body by glue. It should be understood that this application is not limited by the specific composition and amount of the glue.

By arranging the lamination-holding component being coupled to the body by glue, the lamination-holding component can be firmly coupled and positioned inside the body on the basis of improving the structural strength and rigidity of the body of the motor component.

In some embodiments, a surface of the lamination-holding component is provided with a texture. For example, the texture may be provided only in a part of the area of the surface of the lamination-holding component, or it may be provided on the entire surface of the lamination-holding component. The texture is intended to increase a contact area between the lamination-holding component and the glue, and it may be in the shape of serrations, threads and the like, for example. The embodiments of the present disclosure are not limited by the arranging location, arranging area, and arranging shape of the texture on the surface of the lamination-holding component.

Based on the above description, by providing a texture on the surface of the lamination-holding component, the contact area between the lamination-holding component and the glue can be effectively increased when the lamination-holding component is coupled to the body by the glue, so that the lamination-holding component can be more firmly fixed inside the body of the motor component, thereby further improving the structural strength and rigidity of the body of the motor component.

In some embodiments, the texture is serrations or threads. It should be understood that the embodiments of the present disclosure are not limited by the density and specific shape of the serrations or threads. By providing the texture as serrations or threads, the contact area between the lamination-holding component and the glue can be effectively increased when the lamination-holding component is coupled to the body by the glue, and the manufacturing process is relatively simple compared with other types of texture, which facilitates simplifying the manufacturing process.

In some embodiments, the laminate holding component is made of non-magnetic material. By providing the laminate holding component as non-magnetic material, influence of the laminate holding component on the magnetic field and electric field of the motor can be reduced when the motor component of the motor is in operation, thereby further improving the performance of the motor component.

In some embodiments, the lamination-holding component is coupled to the body by interference fit with the axially extending cavity. By coupling to the body using interference fit, on the one hand, the lamination-holding component can be firmly coupled to and positioned in the body, and on the other hand, it is unnecessary to use other additional components to realize connection therebetween, which simplifies the composition structure of the motor component.

In some embodiments, the axially extending cavity is a through-groove or a through-hole. Based on the above description, by providing the axially extending cavity as a through-groove or a through-hole, on the one hand, a slot structure of the motor component itself can be reused, which facilitates streamlining the structure of the motor component and simplifying the manufacturing process of the motor component; On the one hand, an overall extension length of the axially extending cavity is also increased, which facilitates more flexible arrangement of the lamination-holding component inside the axially extending cavity.

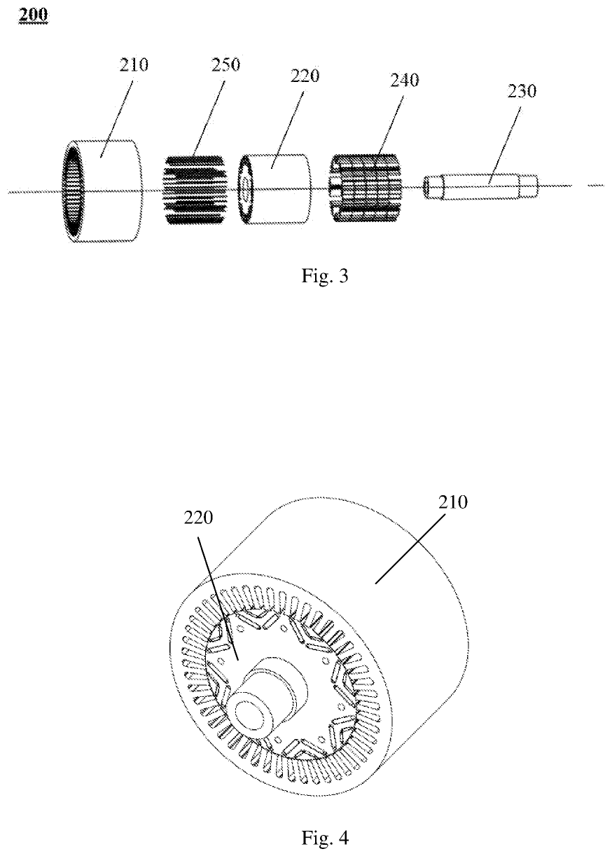

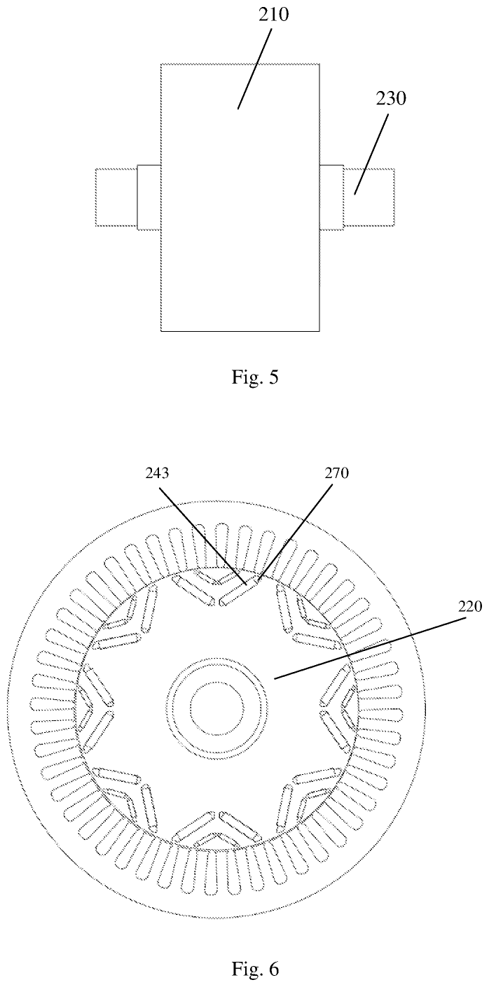

In some embodiments, the axially extending cavity is a permanent magnet mounting slot. FIG. 3 shows an exploded view of a motor 200 according to an embodiment of the present invention, in which the permanent magnet mounting slot in the motor rotor 220 serves as the axially extending cavity. FIG. 4 shows a perspective view of the motor 200 in FIG. 2, and FIG. 5 shows a front view of the motor 200 in FIG. 2.

Next, this embodiment will be described in more detail with reference to FIGS. 3 to 5. Referring to FIG. 3, it shows a motor 200 according to an embodiment of the present invention. The motor may be, for example, a permanent magnet motor, and the motor 200 includes, for example, a motor stator 210, a motor rotor 220, and a motor shaft 230. The motor rotor 220 is mounted on the motor shaft 230 by interference fit, for example. In addition, the motor rotor 220 is provided with a plurality of longitudinally penetrating permanent magnet mounting slots (one permanent magnet mounting slot 270 is labeled in FIG. 6), and a plurality of permanent magnets 240 are respectively mounted in the plurality of permanent magnet mounting slots.

With further reference to FIG. 3, when the motor rotor 220 is used as the motor component in the present application, and the permanent magnet mounting slots of the motor rotor 220 are used as the axially extending cavity, a plurality of lamination-holding components 250 will be arranged in the permanent magnet mounting slots.

Next, referring to FIGS. 6 to 8, an exemplary arrangement of the lamination-holding components in the permanent magnet mounting slots will be described in more detail.

Referring to FIG. 6, it shows a side view of the motor 200, in which the motor rotor 220 is not provided with a lamination-holding component. A permanent magnet mounting slot 270 on the motor rotor 220 and a permanent magnet 243 mounted in the permanent magnet mounting slot 270 are labeled.

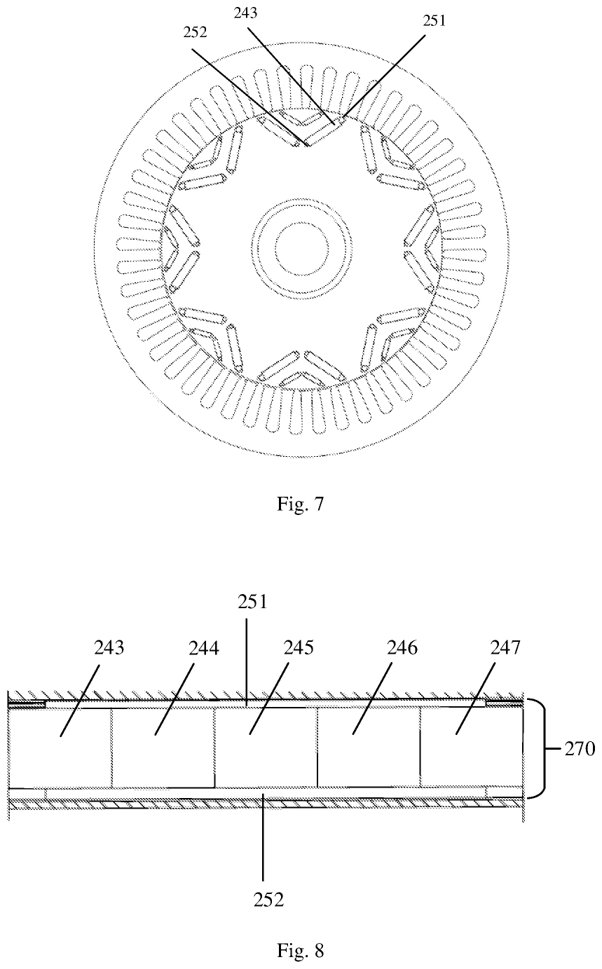

With further reference to FIG. 7, there is shown a side view of the motor 200 in which the motor rotor 220 is provided with a lamination-holding component. In addition, two lamination-holding components 251, 252 are arranged inside the permanent magnet mounting slot 270 provided with the permanent magnet 243, for example, which are respectively arranged in gaps between the permanent magnet mounting slot and two ends of the permanent magnet.

Referring to FIG. 8, it shows an axial cross-sectional view of the permanent magnet mounting slot 270 in the motor rotor 220, in which there are shown the permanent magnet mounting slot 270 penetrating the motor rotor in the axial direction and five permanent magnets sequentially arranged in the slot, which respectively are: permanent magnet 243, permanent magnet 244, permanent magnet 245, permanent magnet 246, and permanent magnet 247. Moreover, it can be seen from FIG. 8 that a lamination-holding component 251 and a lamination-holding component 252 are provided in the gaps between the five permanent magnets and the permanent magnet mounting slot 270.

It should be understood that the foregoing only provides an exemplary arrangement of the lamination-holding component when the axially extending cavity is a permanent magnet mounting slot. Other arrangements may also be adopted based on practical requirements, for example, lamination-holding components are provided in only part of the permanent magnet mounting slots, or a single lamination-holding component is provided in only a single permanent magnet mounting slot, or the like. The embodiments of the present disclosure are not limited to the above-mentioned mounting manners.

Based on the above description, by providing the axially extending cavity as a permanent magnet mounting slot, a slot structure of the motor component itself can be reused, thereby facilitating streamlining the structure of the motor component and simplifying the manufacturing process of the motor component.

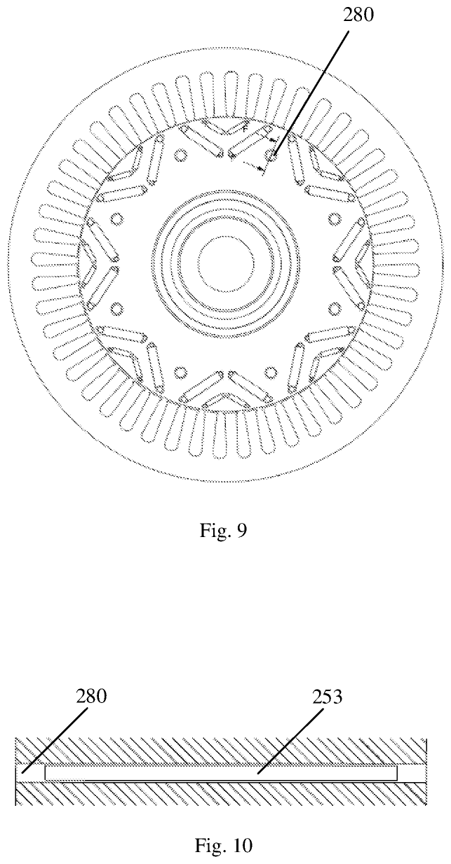

In some embodiments, the axially extending cavity is a balance pin mounting slot. FIG. 9 shows a side view of a variant of the motor 200 according to an embodiment of the present disclosure. The motor rotor of the motor 200 is also provided with a plurality of balance pin mounting slots, and one balance pin mounting slot 280 is labeled in FIG. 9.

Further referring to FIG. 10, it shows an axial cross-sectional view of the balance pin mounting slot 280 of the motor rotor 220. It can be seen from FIG. 10 that, a lamination-holding component 253 is provided in the balance pin mounting slot 280, for example.

Based on the above description, by providing the axially extending cavity as a balance pin mounting slot, a slot structure of the motor component itself can be reused, thereby facilitating streamlining the structure of the motor component and simplifying the manufacturing process of the motor component.

In some embodiments, the lamination-holding component is a rod having a cross section of square, rectangular, circular or elliptical. For example, the lamination-holding component may be a flat rectangular rod, for example.

By providing the lamination-holding component with different cross-sectional shapes, the lamination-holding component can be well adapted to the axially extending cavities of different shapes, thereby achieving a stable connection with the structure of the body of the motor component.

According to another aspect of the present disclosure, a motor is provided, which includes the motor component as described above, can realize the functions of the motor component as described above, and has the advantages as described above.

In some embodiments, the motor may further include other components, such as a motor shaft, bearings arranged on the motor shaft, blades, wires and the like. The embodiments of the present disclosure are not limited by the type of the motor and its specific composition structure.

According to another aspect of the present disclosure, a motor vehicle is provided, which includes the motor as described above.

The motor vehicle may be a plug-in hybrid electric vehicle, or it may also be a battery electric vehicle or other types of motor vehicles. The embodiments of the present disclosure are not limited by the specific type of the motor vehicle.

Based on the above description, the motor vehicle can realize the functions of the motor components and the motor as described above, and has the advantages as described above.

This application uses specific words to describe the embodiments of the present application. For example, “first/second embodiment”, “an embodiment”, and/or “some embodiments” mean a certain feature, structure, or characteristic related to at least one embodiment of the present application. Therefore, it should be emphasized and noted that “an embodiment”, “one embodiment” or “an alternative embodiment” mentioned twice or more in different positions of this specification does not necessarily refer to the same embodiment. In addition, some features, structures, or characteristics in one or more embodiments of the present application may be appropriately combined.

Unless otherwise defined, all terms (including technical and scientific terms) as used herein have the same meaning as commonly understood by those of ordinary skill in the art to which the present invention belongs. It should also be understood that terms such as those defined in ordinary dictionaries should be interpreted as having meanings consistent with their meanings in the context of related technologies, and should not be interpreted in idealized or extremely formalized meanings, unless explicitly defined herein.

The above is an illustration of the present invention, and should not be considered as a limitation to it. Although several exemplary embodiments of the present invention have been described, those skilled in the art will readily understand that many modifications may be made to the exemplary embodiments without departing from the novel teachings and advantages of the present invention. Therefore, all these modifications are intended to be included in the scope of the present invention defined by the claims. It should be understood that the above is an illustration of the present invention and should not be considered as being limited to the disclosed specific embodiments, and modifications to the disclosed embodiments and other embodiments are intended to be included in the scope of the appended claims. The present invention is defined by the claims and equivalents thereof.

1. A motor component having a body extending along a rotation axis of the motor, the body being formed by a set of laminations, and an axially extending cavity being provided on the body; and
wherein at least one elongated lamination-holding component is provided in the body, and the lamination-holding component is inserted into the axially extending cavity and is coupled to the body inside the axially extending cavity.

2. The motor component according to claim 1, wherein the motor component is a motor stator or a motor rotor.

3. The motor component according to claim 1, wherein the lamination-holding component extends over a portion of a length of the axially extending cavity.

4. The motor component according to claim 1, wherein the lamination-holding component extends over the entire length of the axially extending cavity.

5. The motor component according to claim 1, wherein the lamination-holding component is coupled to the body by glue.

6. The motor component according to claim 5, wherein a surface of the lamination-holding component is provided with a texture.

7. The motor component according to claim 6, wherein the texture is serrations or threads.

8. The motor component according to claim 1, wherein the laminate holding component is made of non-magnetic material.

9. The motor component according to claim 1, wherein the lamination-holding component is coupled to the body by interference fit with the axially extending cavity.

10. The motor component according to claim 1, wherein the axially extending cavity is a through-groove or a through-hole.

11. The motor component according to claim 1, wherein the axially extending cavity is a permanent magnet mounting slot.

12. The motor component according to claim 1, wherein the axially extending cavity is a balance pin mounting slot.

13. The motor component according to claim 1, wherein the lamination-holding component is a rod having a cross section of square, rectangular, circular or elliptical.

14. A motor comprising the motor component according to claim 1.

15. A motor vehicle comprising the motor according to claim 14.

16. A motor comprising the motor component according to claim 2.

17. A motor comprising the motor component according to claim 3.

18. A motor comprising the motor component according to claim 4.

19. A motor comprising the motor component according to claim 5.

20. A motor comprising the motor component according to claim 6.
